(19) United States
(12) Patent Application Publication
(10) Pub. No.: US 2026/0111946 A1
(43) Pub. Date: Apr. 23, 2026

(54) METHOD AND SYSTEM FOR ELECTRICAL COMPONENT MATCHING

(71) Applicant: Elisa Oyj, Helsinki (FI)

(72) Inventors: Eero Hiltunen, Helsinki (FI); Antti Liski, Helsinki (FI); David Sharp, Murphy, TX (US); Mike Turner, Murphy, TX (US)

(73) Assignee: Elisa Oyj, Helsinki (FI)

(21) Appl. No.: 19/117,631

(22) PCT Filed: Nov. 14, 2023
(86) PCT No.: PCT/FI2023/050629

§ 371 Date: Apr. 1, 2025

(30) Foreign Application Priority Data
Dec. 5, 2022 (FI) 20226075

(51) Int. Cl. G06Q 30/0601

(52) U.S. Cl. CPC G06Q 30/06314

(57) ABSTRACT

A method for electrical component matching. The method includes receiving an input indicative of a given electrical component for which at least one matching electrical component is required to be identified; inferring specifications of the given electrical component using the input; determining a first set of electrical components from amongst the plurality of electrical components using rule-based cases applied corresponding to the specifications; determining a second set of electrical components from amongst the plurality of electrical components using machine learning; generating raw output data comprising product data of the electrical components of the first set and the second set; and processing the raw output data for generating processed output data.

### TECHNICAL FIELD

The present disclosure relates to methods for electrical component matching. The present disclosure relates to systems for electrical component matching.

### BACKGROUND

In the recent decade, electrical and electronic components have revolutionized the way of living and become an important part of a manufacturing process of any device. A quality of electrical and electronic components used for developing the device effectively determines a growth and future of said device. Furthermore, a durability and functionality of the device completely depends on a quality of the electrical and electronic components used in the manufacturing of the device. For the sake of brevity, hereinafter, the term “electrical and electronic components” is used interchangeably with a term “component”.

Due to supply chain issues, such as, supply shortage, unavailability, defectiveness, of the component, about a third of a total number of components are unavailable for immediate sale. Depending on a situation, an alternate component for a given component can be difficult to find, as it is required for the alternate component to be similar to at least one of: a specification, a package size, a processing technique, of the given component. The alternate component can be found at at least one of: an electronic commerce website, a physical store, and the like. However, descriptions of the alternate components which match the given component may be different from each other. Hence, the alternate components are determined to be different due to the difference in the descriptions, even said alternate components may have a high similarity to the given component.

Despite progress in searching techniques associated with at least one of: the electronic commerce website, the physical store, in finding the alternate component for the given component, existing searching techniques has several limitations associated therewith. Firstly, the alternate components for the given component can be searched by image. However, the images may not be accurate due to varying sizes of the alternate components, such as, for example, the sizes may vary from a diode of 0.08 millimetre (mm) to a transformer of several meters Further searching manually using search engines and crawling web pages to find information related to components requires lots of work and time. Also, since content and web page layouts (page mapping) change, the search will bring different results depending on when the search is done.

Therefore, in light of the foregoing discussion, there exists a need to overcome the aforementioned drawbacks associated with existing techniques for finding the alternate component for the given component.

### SUMMARY

The present disclosure seeks to provide a method for electrical component matching. The present disclosure also seeks to provide a system for electrical component matching. An aim of the present disclosure is to provide a solution that overcomes at least partially the problems encountered in prior art.

In a first aspect, the present disclosure provides a method for electrical component matching, the method comprising:
receiving an input indicative of a given electrical component for which at least one matching electrical component is required to be identified, wherein the input comprises at least one of: a given manufacturer part number, a given description, of the given electrical component;
inferring specifications of the given electrical component using the input, from a dataset comprising product data of a plurality of electrical components;
determining a first set of electrical components from amongst the plurality of electrical components using rule-based cases applied corresponding to the specifications, wherein the electrical components of the first set match the given electrical component;
determining a second set of electrical components from amongst the plurality of electrical components using machine learning, wherein the electrical components of the second set match the given electrical component;
generating raw output data comprising product data of the electrical components of the first set and the second set; and
processing the raw output data for generating processed output data, wherein the processed output data comprises product data of the at least one matching electrical component identified from amongst the electrical components of the first set and the second set and a confidence of matching between the given electrical component and the at least one matching electrical component.

In a second aspect, the present disclosure provides a system for electrical component matching, the system comprising at least one processor configured to implement steps of the method of the first aspect.

Embodiments of the present disclosure substantially eliminate or at least partially address the aforementioned problems in the prior art, and enable efficient matching of electrical components to the given electrical component.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is shown an illustration of a flowchart depicting steps of a method for electrical component matching, in accordance with an embodiment of the present disclosure;

FIGS. 2A and 2B is a normalized confusion matrix and a graph corresponding to a performance of a classification model, in accordance with an embodiment of the present disclosure;

FIGS. 3A and 3B is a normalized confusion matrix and a graph corresponding to a performance of a description matcher model, in accordance with an embodiment of the present disclosure;

FIGS. 4A and 4B is a normalized confusion matrix and a graph corresponding to a performance of a manufacturer part number matcher model, in accordance with an embodiment of the present disclosure;

FIG. 5. is an exemplary view of a user interface during a purchase process performed by an entity, in accordance with an embodiment of the present disclosure;

FIGS. 6A and 6B are block diagrams of a system for electrical component matching, in accordance with an embodiment of the present disclosure; and

FIG. 7 is an illustration of flow chart according to embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for electrical component matching, the method comprising:
receiving an input indicative of a given electrical component for which at least one matching electrical component is required to be identified, wherein the input comprises at least one of: a given manufacturer part number, a given description, of the given electrical component;
inferring specifications of the given electrical component using the input, from a dataset comprising product data of a plurality of electrical components;
determining a first set of electrical components from amongst the plurality of electrical components using rule-based cases applied corresponding to the specifications, wherein the electrical components of the first set match the given electrical component;
determining a second set of electrical components from amongst the plurality of electrical components using machine learning, wherein the electrical components of the second set match the given electrical component;
generating raw output data comprising product data of the electrical components of the first set and the second set; and
processing the raw output data for generating processed output data, wherein the processed output data comprises product data of the at least one matching electrical component identified from amongst the electrical components of the first set and the second set and a confidence of matching between the given electrical component and the at least one matching electrical component.

In a second aspect, the present disclosure provides a system for electrical component matching, the system comprising at least one processor configured to implement steps of the method of the first aspect.

The present disclosure provides the aforementioned method, and the aforementioned system for facilitating a simple, fast, accurate, and improved technique for electrical component matching by way of using product data to search for at least one matching electronic component. Depending on a situation, the at least one matching component can be determined by using at least one of: the given description, the given manufacturer part number. The given description can further be parsed and divided into logical syntactic components, to provide the at least one matching electrical component accurately, irrespective of a size of the given electrical component. Furthermore, the method and the system are robust, reliable, user friendly, and can be used for comparing at least one of: a price, a product portfolio, a copyright infringement, of the at least one matching electrical component.

Throughout the present disclosure, the term “electrical component” refers to a component of an electric circuit. Examples of the electrical component may include, but are not limited to, a wire, a switch, a resistor, a capacitor, an inductor, a diode, a transistor, an adhesive, and the like. The given electrical component is a component for which the at least one matching electrical component is required to be identified, since the at least one matching electrical component serves a similar functionality as the given electrical component.

The at least one matching electrical component identified for the given electrical component is a component whose electrical characteristics and physical characteristics are at least partially similar to the given electrical component. The at least one matching electrical component is identified from amongst the plurality of electrical components. A technical benefit of identifying the at least one matching electrical component is that, when the given electrical component is unavailable, defective, short on supply, or similar, then the at least one matching electrical component can be used in place of the given electrical component. Optionally, the electronic component matching may be performed by a search engine. The search engine may be deployed on an e-commerce platform, on an educational platform, on a business platform, or similar. The input may be received in real time or near-real time.

The given manufacturer part number is a unique identification number of the given electrical component, which is decided by a manufacturer of the given electrical component. The given manufacturer part number enables differentiation of the given electrical component from similar electrical components. The given manufacturer part number may include one or more of numbers, alphabets, symbols, such as, for example, “100-440-0.250-1414”, “1B-3-N-7690”, and similar. The given manufacturer part number may be coded into a barcode, a QR code, an RFID tag, and the like.

The given description of the given electrical component may be a text describing or listing out, electrical characteristics and physical characteristics of the given electrical component. The given description may be several characters long, and may include one or more of numbers, alphabets, symbols, punctuation marks, and the like. Optionally, the input also comprises the manufacturer of the given electrical component.

Throughout the present disclosure, the “specifications” of the given electrical component refers to the electrical characteristics and the physical characteristics of the given electrical component. The specifications of the given electrical component are inferred from the dataset. Examples of the specifications may include, but are not limited to, two or more of: a resistance value, a capacitance value, an inductance value, a temperature coefficient rating, a voltage rating, a power rating, a maximum temperature, a construction type, a component type, a mounting configuration, and the like. The dataset is a collection of specifications for the plurality of electrical components. The dataset may be in a form of at least one of: a table, a matrix, a list, a datasheet. The dataset comprises the product data for the plurality of electrical components, which is the related sets of specifications for the plurality of electrical components. The “product data” is information about the plurality of electrical components which can be read, analysed, and structured into a usable format. The product data may comprise at least one of: the description, the manufacturer part number, the manufacturer, of the plurality of electrical components. The specifications of the given electrical component are inferred using the input from the dataset, so as to know different ways by which the given electrical component is described or is presented, in the dataset, such knowledge being used to identify the at least one matching electrical component. A technical advantage of inferring specifications of the given electrical component is that at least one property concerning usability and/or functionality of the given electrical component is extracted from the dataset using the input, so as to identify the at least one matching electrical component accurately.

Optionally, the step of inferring the specifications of the given electrical component using the input comprises:
inferring the given description of the given electrical component when the input excludes the given description, based on at least one description associated with the given manufacturer part number in the dataset and a count of the at least one description;
inferring a class of the given electrical component using a pre-trained classification model, based on the given description of the given electrical component; and
inferring at least one attribute of the given electrical component using at least the at least one description. According to alternative embodiment there might not be any attribute for the component in said case the last step of “inferring at least one attribute” is omitted.

In this regard, a technical advantage of inferring the specifications of the given electrical component is to extract at least one of: the given description, the class, the at least one attribute, from existing information (i.e., the dataset) to identify the at least one matching electrical component for the given electrical component properly and accurately. In this regard, the given description of the given electrical component is inferred when only the given manufacturer part number is received as the input. The at least one description for the given manufacturer part number may be written in varying formats, text, codes, in the dataset. When inferring the given description, the given manufacturer part number of the given electrical component is searched throughout the dataset to find the at least one description associated with the given manufacturer part number. Then, the at least one description associated with the given manufacturer part number is used to infer the given description. Herein, the “count” of the at least one description refers to a numeric value of number of times that the at least one description is associated with the given manufacturer part number, in the dataset. The at least one description is optionally arranged in a decreasing order of the count of the at least one description. The given description for the given electrical component is inferred from the at least one description. For example, as a content of a description having highest count, a combination of all content from the at least one description, a matching content from the at least one description, a collection of distinct content from the at least one description, or similar.

Subsequently, the given description is then used to infer the class of the given electrical component. The given description of the given electrical component is utilised by the classification model to predict the class of the given electrical component. Herein, the class of the given electrical component refers to a category of electrical components sharing similar electrical and physical characteristics. The class may be a pre-known class or may be defined by the classification model. The class may be written as a whole word, or in form of keywords. Examples of the class of the given electrical component may include, but are not limited to, a resistor, a capacitor, a diode, an inductor, a connector, and the like. Furthermore, the class may be divided into further sub-classes, to improve accuracy of the classification model. For example, the class of electromechanical components may have sub-classes that may include, but are not limited to, a linear resistor, a fixed resistor, a variable resistor, a non-linear resistor, and the like. The classification model is pre-trained using the dataset.

It will be appreciated, that the classification model is pre-trained on the dataset. As an example of training can be carried out by generating a data set in which obvious key words which can be found in simple keyword search are removed. This way the trained network is able to identify components which are not labelled/described properly in target sites/information sources. Herein, a normalised confusion matrix is used to determine a performance of the classification model. The normalised confusion matrix is used when the class of the given electrical component is inferred from one or more classes of the electrical components associated with the given manufacturer part number. Herein, “normalised” refers to each grouping of the one or more classes that are represented as having 1.00 sample of the class. Hence, a sum of each row in the normalised confusion matrix is 1.00, as the sum of each row represents the one or more classes. Herein, each row of the normalized confusion matrix represents an instance of any of the actual class or the predicted class while the column represents another of the actual class and the predicted class. Each cell in the normalized confusion matrix has a numeric value ranging from 0 up to 1.

Subsequently, an accuracy of performance of the classification model is checked by an area under a receiver operating characteristics (ROC-AUC) curve. The ROC curve is a graph that is plotted between a true positive rate (TPR) and a false positive rate (FPR), of inferring the class of the given electrical component, on vertical axis and horizontal axis, respectively. Herein, the ROC curve provides a summary of the performance of the classification model by combining the normalized confusion matrices of the classes inferred for the given electrical component. The AUC provides an aggregate measure of classification by the classification model across the one or more classes, which is known as AUC score. The AUC score is a numeric value, wherein the numeric value may range from 0 up to 1. In one instance, when the AUC score approaches 1, it means that the classification model has a good measure of separability between the classes. In another instance, when the AUC score is 0.5, it means that the classification model has no capacity to separate the classes of the plurality of electrical components and infer the class for the given electrical component.

Optionally, the at least one attribute is inferred from the at least one description by voting using votes. Herein, the term “votes” refers to a numeric value of number of times the at least one attribute associated with the given electrical component, is present in the dataset. The at least one attribute may be written in varying formats, texts, in the at least one description. When inferring the at least one attribute, at least the at least one description associated with the given electrical component is searched thoroughly to find the at least one attribute associated with said electrical component. Then, the at least one description is used to infer the at least one attribute. The at least one attribute is then arranged in a decreasing order of the votes. Optionally, the at least one attribute of the given electrical component is also inferred using the class inferred of the given electrical component. For example, the at least one attribute may be a resistance value, which may not be present when the given electrical component is a capacitor.

Optionally, the step of inferring the specifications of the given electrical component using the input further comprises inferring the manufacturer of the given electrical component, based on at least one manufacturer associated with the given manufacturer part number in the dataset and a count of the at least one manufacturer. The at least one manufacturer is then arranged in decreasing order of the count of the at least one manufacturer. The given manufacturer of the given electrical component is inferred from the at least one manufacturer, starting from the count having the highest numeric value to optionally, to the lowest numeric value.

Optionally, the classification model is utilized for creating subsets of the electrical components in the plurality of the electrical components. Herein, the classification model classifies the electrical components into a plurality of sets depending on their classes.

In a first example, the given manufacturer part number received as input may be ‘CC0603JRNPO9BN221’. The given description inferred based on at least one description associated with the ‘CC0603JRNPO9BN221’ may be ‘RES SMD 1K OHM 1/16 W 0402’ and the count of the at least one description may be ‘{′RES SMD 1K OHM 1% 1/16 W 0402′: 21, ′RES 1K OHM 1% 1/16 W 0402′: 21, ′RES 1K OHM 1/16 W 1% 0402’: 15, ′RES SMD 1K OHM 1% 1/16 W THICK FILM 0402′: 8, ′RES 1.00K OHM 1/16 W 1% 0402 SMD′:5, ′Res Thick Film 0402 1K Ohm 1% 0.1 W (1/10 W)±100 ppm/° C. Pad SMD Automotive T/R′:3}’. Thereafter, the class of the given electrical component may be inferred to be ‘res’. Subsequently, the given attribute of the given electrical component may be inferred from the at least one attribute by voting using votes, as given by ‘‘resistance’: 1000.0, ‘power’: 0.0625, ‘tolerance’: 1.0, ‘case’: 0402, ‘voltage’: 50.0’. Optionally, the manufacturer of the given electrical component may be inferred, based on the at least one manufacturer associated with the given manufacturer part number in the dataset and the count of the at least one manufacturer, such as, ‘{′STACKPOLE ELECTRONICS′:126, ‘STACKPOLE’:93, ‘SEI’:47, ‘STACKPOL’:11, ‘SEI ELECTRONICS’:7}’.

Optionally, the step of inferring the at least one attribute of the given electrical component using at least the at least one description comprises parsing the at least one description to identify at least one of: a unit, a value, an expression, a sequence, related to the at least one attribute. Herein, the at least one description is parsed to analyse at least the at least one description, by dividing the at least one description into logical syntactic components. A technical advantage of parsing of the at least one description is that this allows for redundancy, and is scalable in nature. Herein, the “redundancy” is a provision of a backup in case of supply shortage, unavailability, defectiveness, of the given electrical component, thereby ensuring that the aforementioned method functions efficiently. Optionally, the method further comprises cleaning the at least one description for removing unwanted content and/or undesired content, prior to parsing the at least one description. Then, the at least one attribute that are most commonly present in the at least one description is parsed. Herein, parsing supports various units, such as, capacitance, voltage, frequency, and the like.

Optionally, the at least one description is parsed to identify the expression (for example, such as, regular expressions) using a search pattern. This search pattern may be further utilised to identify sequences in the at least one description. Advantageously, such search pattern is time efficient, such as, for example, the search pattern may require approximately 8 minutes to parse per 2 million descriptions in the dataset. The at least one attribute of the given electrical component is also inferred by parsing at least one of the: the class, the manufacturer part number, the manufacturer. In one example, an exemplary search pattern to identify a value of resistance (i.e., an attribute) of a resistor (i.e., the given electrical component) in at least the at least one description may be, ‘\b[\d*\.?\d+]+\w*ohm’. Herein, reading the search pattern from left to right, ‘\b’ denotes beginning of at least one attribute, ‘\d’ denotes either a null value or a plurality of digits, ‘.’ denotes either a null value or a decimal point, ‘\d’ denotes at least one digit, and ‘\w’ either denotes a null value or a plurality of characters. In another example, another exemplary search pattern to identify a case of the given electrical component in at least the at least one description may be, ‘\b\d{4}\b’. Herein, reading the search pattern from left to right, ‘\b’ denotes beginning of at least one attribute, ‘\d{4}’ denotes a number having four digits, and ‘\b’ denotes ending of the at least one attribute.

The first set of electrical components is a set of one or more electrical components that match the given electrical component. The rule-based cases are applied corresponding to the specifications, so that if any one of the rule-based cases are satisfied, the one or more electrical components in the plurality of electrical components is identified to belong to the first set. A technical advantage of using the rule-based cases is that it is possible to verify that the first set matches the given electrical component, as the rule-based cases can be interpreted easily. Furthermore the rule-based model is predictable and provides each time the rule is applied same results.

Optionally, the step of determining the first set of electrical components from amongst the plurality of electrical components using rule-based cases applied corresponding to the specifications comprises identifying an electrical component in the plurality of electrical components to belong to the first set when:
a manufacturer part number of the electrical component is same as the given manufacturer part number, but a manufacturer of the electrical component is different from a manufacturer of the given electrical component;
a description of the electrical component is same as the given description of the given electrical component, but a manufacturer and/or a manufacturer part number of the electrical component is different from a manufacturer and/or the given manufacturer part number of the given electrical component;
a manufacturer part number of the electrical component is different from the given manufacturer part number, but a description of the electrical component is same as the given description of the given electrical component; or
a manufacturer part number of the electrical component is same as the given manufacturer part number and a description of the electrical component is same as the given description of the given electrical component.

Indeed we can identify plurality of different descriptions for given manufacturer part number. Further the plurality of identified different descriptions are used to find yet another set of descriptions which have common content parts of the plurality of identified descriptions. From this another set of descriptions we can find alternative manufacture part numbers which correspond to the given manufacturer part number. This way we can find link between manufacturer part numbers of two or more manufactures for the same components.

In this regard, the aforesaid rule-based cases are used to determine the one or more electrical components that seemingly match the given electrical component. When any specifications of the one or more electrical components satisfy any one of these rule-based cases, that electrical component is added to the first set. The first set of electrical components determined in this manner have at least partially the same specification as the given electrical component. Advantageously, using rule-based cases is cost efficient and accurate in terms of the electrical components present in the first set.

When, the manufacturer part number of the electrical component is same as the given manufacturer part number, but the manufacturer of the electrical component is different from the manufacturer of the given electrical component, the description of the electrical component can be different from the given description of the given electrical component, or it may not be present altogether. Since the manufacturer part number and the given manufacturer part number are same, it means that even if the electrical component is manufactured by a manufacturer different than the given manufacturer, the electrical component can match the given electrical component. In such a case, the electrical component may have been manufactured using specifications which are same as the specifications of the given electrical component. Hence, this electrical component is identified to belong to the first set. For example, the given manufacturer part number of the given electrical component may be ‘RMC1206FT10M0’, and the manufacturer part number of the electrical component in a plurality of electrical components may be ‘RMC1206FT10M0’, which are same. However, the given manufacturer of the given electrical component may be ‘Stackpole’, whereas the manufacturer of the electrical component may be for example ‘Manufacturing Corp’. The electrical component is thus identified to belong to the first set. According to additional embodiment manufacturer names can be normalized i.e different versions of name such as Manufacturing Corp, Manufacturing Corporation, Manufacturing Ltd etc will be associated with agreed normalized name such as “Manufacturing Corp”

When the description of the electrical component is same as the given of the given electrical component, but the manufacturer and/or the manufacturer part number of the electrical component is different from the manufacturer and/or the given manufacturer part number of the given electrical component, the electrical component is not an exact match to the given electrical component, based on the manufacturer part number and the given manufacturer part number, and/or when the electrical component is not manufactured by the manufacturer same as the given manufacturer. However, the electrical component still matches the given electrical component. based on the same description, as the description of the electrical component has the same terminology as the given description of the given electrical component. Hence, the electrical component is identified to belong to the first set. For example, the given description of the given electrical component may be ‘RES 10M OHM 1% 1/4 W 1206’ and there may be three electrical components in the plurality of electrical components having the description ‘RES 10M OHM 1% 1/4 W 1206’, which is same as the given description. However, the manufacturer and the manufacturer part number of the three electrical components may be ‘KOA’ and ‘RK73H2BTTD1005F, ‘SET’ and ‘RMCF1206FG10M0’, and ‘STACKPOLE’ and ‘RMCF1206FG10M0’, respectively. The given manufacturer and the given manufacturer part number may be ‘Stackpole’ and ‘RMCF1206FT10M0’, respectively. Hence, the three electrical components match the given electrical component and is identified to belong to the first set.

When the manufacturer part number of the electrical component is same as the given manufacturer part number, but the description of the electrical component is different from the given description of the given electrical component, the manufacturer of the electrical component may either be the given same manufacturer or be different than the given manufacturer. In this case, the electrical component may be manufactured in a manner similar to the given electrical component, as the manufacturer part number is same as the given manufacturer part number. However, when the electrical component is manufactured by a manufacturer different than the given manufacturer, the electrical component may be described differently by the manufacturer, although the electrical component can match the given electrical component. Hence, the electrical component is identified to belong to the first set. For example, the given manufacturer part number may be ‘RMCF1206FT10M0’, and the manufacturer part number of the electrical component may be ‘RMCF1206FT10M0’, which are same. However, the given description may be ‘RES 10M OHM 1% 1/4 W 1206’, and the description of the electrical component may be ‘RES 1.00M OHM 1/4 W, 1% 1206 SMD’, which are different. Hence, the electrical component is identified to belong to the first set because the manufacturer part number is same as the given manufacturer part number.

As a further example the manufacturer part number (for example 123) of the electrical component can correspond to a set of descriptions of the given electrical component. The set of descriptions are thus associated with the manufacturer part number. Furthermore one or more of the descriptions of the set of descriptions can be used to identify another set of descriptions which are at least party similar or corresponds to the one or more of the descriptions. In practice there might be another description which has the same text as one of the descriptions of the set of descriptions. The another description might however indicate different manufacturer part number (for example 321). This way the manufacturer part number (in this example 123) can be associated with different manufacturer part number (example 321). This further helps to match, the electrical component the given electrical component. Hence, the electrical component is identified to belong to the first set. For example, there may be three electrical components whose manufacturer part numbers and descriptions, respectively, are same as the given manufacturer part number and the given description of the given electrical component. The given manufacturer of the given electrical component may be ‘Stackpole’. However, the manufacturer of the three electrical components may be ‘VISHAY, ‘ROHM’, and ‘YAGEO’, respectively. Hence, the three electrical components are identified to belong to the first set.

The second set of electrical components is a set of one or more electrical components that may at least match the given electrical component. Such matching is determined using the machine learning. Herein, machine learning is employed to identify the one or more electrical components from amongst the plurality of electrical components to belong to the second set. A technical advantage of using machine learning is that it helps to process and analyse the plurality of electrical components quickly (i.e., when compared to conventional methods) to determine the second set, and provides a modified way for the set of one or more electrical components that at least matches the given electrical component. Further technical benefit is that machine learning helps to find automatically a set of rules to identify and find similar and matching components. Herein, each electrical component from amongst the plurality of electrical components and the given electrical component can be paired with paired, and a pairwise similarity algorithm is employed for computing a similarity function. Herein, the similarity function is a real-valued function that quantifies a similarity between each electrical component and the given electrical component. The real-valued function may lie in a range from 0 up to 1. This helps to evaluate at least one relationship between the electrical component and the given electrical component. The at least one relationship can also be quantified using a numerical value, wherein the numerical value indicates a strength of association (i.e., a level of similarity) between the electrical component and the given electrical component. Optionally, in this regard, greater the numerical value, higher is the level of similarity. Indeed benefit of using machine learning model (in essence statistical model) is that it provides way to identify those components which are not found using the rule-based model. Based on the embodiments the mix of rule-based and the machine learning based has found out to be surprisingly efficient. Rule-based will provide those components which can be identified by the rules. Machine learning model, by its nature, provides probabilistic (second) set of components. Combination or fusion of the first set and the second set of electrical components is thus a set which will have certain 100% correct hits (rule bases) and certain probabilistic (those with probability being above set limit or within range) hits thus combining best of both models. This has been found out to provide better results than using only rule based or only machine learning based methods for component finding and matching.

Optionally, the step of determining the second set of electrical components from amongst the plurality of electrical components using machine learning comprises:
determining a third set of electrical components from amongst the electrical components, wherein the electrical components of the third set are similar to the given electrical component;
employing at least one of:
   a pre-trained description matcher model for determining first similarity values indicative of a similarity between descriptions of the electrical components in the third set and the given description of the given electrical component;
   a pre-trained manufacturer part number matcher model for determining second similarity values indicative of a similarity between manufacturer part numbers of the electrical components in the third set and the given manufacturer part number of the given electrical component;
comparing the first similarity values and/or the second similarity values against a first threshold value and/or a second threshold value, respectively; and
identifying an electrical component in the third set to belong to the second set when its first similarity value and/or second similarity value is/are greater than the first threshold value and/or the second threshold value, respectively.

In this regard, the third set of electrical components are at least partially similar to the given electrical components. A technical advantage of the aforementioned steps is that an extent of similarity, i.e., a given similarity value, between the electrical component in the third set and the given electrical component is determined, so as to determine the second set.

Herein, the given similarity value is at least one of: the first similarity value, the second similarity value. The description matcher model is pre-trained on reference descriptions of reference electrical components. The description matcher model learns a similarity function based on the reference descriptions that are paired with each other. The similarity function computes the first similarity value for each pair of reference descriptions, wherein the first similarity value lies in a range from 0 up to 1. As an example of components which are similar can be for example a first resistor and a second resistor having same resistance within allowed tolerances. For example if needed resistance is 1 kohm, but based on specification of the equipment tolerance of 5% is acceptable then resistors of +−5% of 1 kohm would be considered as similar.

Similarly, the manufacturer part number matcher model is pre-trained on reference manufacturer part numbers of the reference electrical components. The manufacturer part number matcher model learns another similarity function based on the reference manufacturer part numbers. The another similarity function learns in a manner similar to the learning of the aforementioned similarity function. The another similarity function computes the second similarity value for each pair of reference manufacturer part numbers, wherein the second similarity value lies in a range same as the range of the first similarity value.

Thereafter, the first similarity values and/or the second similarity values are compared with the first threshold value and/or the second threshold value, respectively. Herein, the first threshold value and/or the second threshold value are numeric values, respectively. The numeric values may lie in a range from 0 up to 1, or 0 up to 10, or 0 up to 100, and the like. When the first similarity values and/or the second similarity values are greater than the first threshold value and/or the second threshold value, respectively, the electrical component from the third set is identified to belong to the second set. Optionally, when the first similarity values are greater than the first threshold value and/or the second similarity values are lesser than the second threshold value, respectively, the electrical component from the third set is also identified to belong to the second set. Optionally, when first similarity values are lesser than the first threshold value and/or the second similarity values are greater than the second threshold value, respectively, the electrical component from the third set is also identified to belong to the second set.

For example, in an exemplary third set, for a given pair of reference electrical components, a first similarity value may be 0.95 and a first threshold value may be 0.50. A second similarity value may be 0.70, and a second threshold value may be 0.70. The first similarity value is greater than first threshold value, but the second similarity value is lesser than the second threshold value. Hence, the electrical component is identified to belong to the second set.

In an embodiment, the method further comprises:
training a description matcher model using a first training dataset for generating the pre-trained description matcher model, the first training dataset comprising one or more sets of different descriptions matched to a same manufacturer part number; and/or
training a manufacturer part number matcher model using a second training dataset for generating the pre-trained manufacturer part number matcher model, the second training dataset comprising one or more sets of different manufacturer part numbers matched to a same description and/or a same client name.

In this regard, the first training dataset and the second training dataset are used for training the description matcher model and the manufacturer part number matcher model, respectively, prior to determining the first similarity values and the second similarity values, respectively. A technical advantage is that this enables the description matcher model and the manufacturer part number matcher model to function efficiently, thus increasing reliability of said models when compared to conventional models. The first training dataset is optionally obtained when the manufacturer part number of the electrical component amongst the plurality of electrical components, is same as the given manufacturer part number of the given electrical component, but the one or more sets of different descriptions of the electrical component is different from the given description. Then, feature engineering is performed on the first training dataset based on at least one distance metric. Examples of the at least one distance metric may include, but are not limited to, a Jaccard distance metric, a Levenshtein distance metric. When testing the description matcher model, cross-validation is performed with the first training dataset and a data used for testing, wherein the one or more sets of different descriptions present in the first training dataset must not be present in the data used for testing the description matcher model.

Optionally, another normalised confusion matrix is used to determine a performance of the description matcher model. The another normalised confusion matrix is a 2×2 matrix plotted between the true description match plotted on vertical axis, and a false description match plotted on horizontal axis. Herein, a first cell in a first row depicts truly negative description match, a second cell in the first row depicts a falsely positive description matcha third cell in a second row depicts falsely negative description match, and a fourth cell in the second row depicts truly positive description match. For example, the normalized confusion matrix may have 0.81 in a first cell, 0.19 in a second cell, 0.22 in a third cell, and 0.78 in a fourth cell.

Subsequently, an accuracy of the performance of the description matcher model is checked by the ROC-AUC curve, in a manner similar to checking the accuracy of performance of the classification model. Then, based on the AUC score and the normalized confusion matrix, a classification report may be generated, wherein the classification report comprises at least one performance metric which evaluates performance of the description matcher model. Herein, the at least one performance metric comprises values which are at least one of: a precision value, a recall value, an F1-score, a support value. Herein, the precision value provides a percentage of a truly positive match between positively predicted descriptions, wherein the precision value may lie between 0 up to 1. The recall value provides a percentage of the positively predicted descriptions, out of total positive descriptions. The F1-score is indicative of a harmonic mean of the precision value and the recall value. Herein, the F1-score takes into account both falsely positive predicted descriptions and falsely negative predicted descriptions. The support value represents number of actual occurrences of the class in the first training dataset. Furthermore, in case of multi-class classification, averaging methods are used for calculation of the F1-score, which results in computation of different average scores, namely, accuracy (otherwise known as micro average), macro average, weighted average, and the like, in the classification report. Herein, the accuracy computes a global average F1-score by counting sums of truly positive match, falsely negative match, and falsely positive match, of the predicted descriptions. The macro average is an arithmetic mean of all the F1-scores. The weighted average is calculated by taking all mean values of all F1-scores while considering the support value of each class. This is as shown in Table 1,

TABLE 1

| | Precision | Recall | F1-score | Support |
|---|---|---|---|---|
| No match | 0.79 | 0.81 | 0.80 | 3612 |
| Match | 0.81 | 0.78 | 0.79 | 3612 |
| Accuracy | | | 0.80 | 7224 |
| Macro average | 0.80 | 0.80 | 0.80 | 7224 |
| Weighted average | 0.80 | 0.80 | 0.80 | 7224 |

The second training dataset is optionally obtained when descriptions and/or the reference client names corresponding to the one or more sets of different manufacturer part numbers matches to the same description and/or same source of data, but the one or more sets of different manufacturer part numbers are different from the given manufacturer part number. Then, feature engineering is performed on the second training dataset based on at least one distance metric, wherein said distance metric is based on character or mean frequencies that are obtained with count vectorizers. Furthermore as an example a classifier is defined which uses concatenated vector representations of for example two input manufacturer part numbers. This vector is fed to machine learning model which have been trained to identify interaction of elements in the vector. This architecture has been found to provide surprisingly high performance results. The architecture is known as “Siamese” architecture. When testing the manufacturer part number matcher model, cross-validation is performed with the second training dataset and a data used for testing, wherein the one or more sets of different manufacturer part numbers present in the second training dataset must not be present in the data used for testing the manufacturer part number matcher model.

Optionally, still another normalised confusion matrix is used to determine a performance of the manufacturer part number matcher model, whose configurations are similar to the another normalised confusion matrix, as described above. For example, the still another normalized confusion matrix may have 0.91 in the first cell, 0.089 in the second cell, 0.18 in the third cell, and 0.82 in the fourth cell.

Subsequently, an accuracy of performance of the description matcher model is checked by the ROC-AUC curve, in a manner similar to when checking the accuracy of performance of the classification model. Then, based on the AUC score and the normalized confusion matrix, another classification report may be generated, wherein the another classification report comprises at least one performance metric which evaluates performance of the description matcher model. The at least one performance metric in the another classification report is same as the at least one performance metric in the classification report. The classification report may be represented as a table, as shown by Table 2

TABLE 2

| | Precision | Recall | F1-score | Support |
|---|---|---|---|---|
| No match | 0.88 | 0.91 | 0.90 | 3600 |
| Match | 0.86 | 0.82 | 0.84 | 2400 |
| Accuracy | | | 0.87 | 6000 |
| Macro average | 0.87 | 0.86 | 0.87 | 6000 |
| Weighted average | 0.87 | 0.87 | 0.87 | 6000 |

In one example, in the first training dataset there may be three electrical components, wherein descriptions of the three electrical components may be ‘RES SMD 1K OHM 1/16 W 0402’, ‘RES 1K OHM 1% 1/16 W 0402’, and ‘RES 1.00K OHM 1/16 W 1% 0402 SMD’, respectively. However, the manufacturer part number for the three electrical components may be ‘CC0603JRNPO9BN221’.

In another example, in the second training dataset there may be three electrical components, wherein the manufacturer part number of the three electrical components may be ‘RK73H2BTTD1005F, ‘CRCW120610M0FKEB’, and ‘CRCW120610M0FKEA’, respectively.

Optionally, the step of determining the third set of electrical components from amongst the electrical components comprises:
identifying, from amongst the plurality of electrical components, at least two of:
   a fourth set of electrical components that have a description that is similar to the given description of the given electrical component;
   a fifth set of electrical components that have a manufacturer part number that is similar to the given manufacturer part number of the given electrical component;
   a sixth set of electrical components that have one or more attributes that are similar to the at least one attribute of the given electrical component; and
identifying an electrical component to belong to the third set when said electrical component belongs to at least two: the fourth set, the fifth set, the sixth set.

A technical advantage of the aforementioned steps is that at least two of: the fourth set, the fifth set, the sixth set helps to determine the third set, by similarly categorizing the at least two of: the description to the given description, the manufacturer part number to the given manufacturer part number, the one or more attributes to the at least one attribute. Herein, the fourth set of electrical components is identified using the Jaccard distance metric, wherein the electrical components have one or more descriptions that are similar to the given description of the given electrical component. Similarly, the fifth set of electrical components is identified using the Levenshtein distance metric, wherein the electrical components have one or more manufacturer part numbers that are at least partially similar to the given manufacturer part number description of the given electrical component. Additionally, optionally, the sixth set of electrical components is identified using the electrical components with one or more attributes similar to the at least one attribute of the given electrical component. Thereafter, at least two of: the fourth set, the fifth set, the sixth set, are processed to identify the electrical component that belongs to the third set. During processing, the electrical component from amongst the plurality of electrical components is predicted when the manufacturing part number of the electrical components in the fifth set is similar to the given manufacturing part number. Similarly, the electrical component from amongst the plurality of electrical components is predicted when the description of the electrical components in the fourth set is similar to the given description. Thereafter, the results are threshold individually and combined to predict the electrical components best suited to belong in the third set. The third set can be a set which matches the set found using machine learning. Sub setting reduces computational time of running inference of machine learning models for descriptions and manufacturer part number matching models.

Optionally, the method further comprises parsing descriptions of the plurality of electrical components to determine attributes of the plurality of electrical components, prior to the step of identifying, from amongst the plurality of electrical components, the sixth set of electrical components. The descriptions of the plurality of electrical components are parsed in a manner similar to parsing at least the at least one description while inferring the at least one attribute of the given electrical component. For example, when the given electrical component is a capacitor, then the descriptions of the plurality of electrical components may be parsed for one or more attributes, such as, capacitance, case, package size, tolerance, voltage rating, from amongst the plurality of electrical components. A technical advantage of parsing the descriptions of the plurality of electrical components is that this allows removal of descriptions that may have unknowingly or knowingly been duplicated in the plurality of electrical components. This reduces, in addition, a memory requirements of used databases.

The raw output data needs to be edited, cleaned or modified to remove at least one of: outliers, duplicates, anomalies, data imperfections, within the product data. The raw output data can be in various formats, such as, for example, a table, a text, a datasheet, and the like. The raw output data generated can, optionally be used as a reference resource data. A technical advantage of this feature is that this enhances accuracy and ensures that credibility of the product data.

The at least one matching electrical component is identified after processing the raw output data, from amongst the electrical components of the first set and the second set. The processed output data further comprises the confidence of matching between the given electrical component and the at least one matching electrical component is an indication of an extent of correctness of the classification. The confidence of matching may be in form of a numerical value, wherein the numerical value may lie in a range from 0 to 1, or 0 to 10, or 0 to 100, and so on. Alternatively, the confidence of matching may be in form of a percentage between a range of 0% to 100%. Alternatively, the confidence of matching may be in form of comparative terms, such as: “Exact”, “High”, “Fair”, “Low”, and so forth. Optionally, electrical components in the first set and the second set are identified to be the at least one matching electrical component when the confidence of matching lies in a range of 60% to 100%. More optionally, the electrical components in the first set and the second set are identified to be the at least one matching electrical component more confidently when the confidence of matching lies in a range of 90% to 100%. As an example, the confidence of matching may lie in a range from 90%, 92%, 95%, or 98% up to 91%, 94%, 97%, or 100%. A technical advantage of generating the processed output data is that it is easier to understand, better displayed, and easier to make decisions, than raw output data. Further an attribute similarity can be calculated using number of attributes found in both the first and the second set divided by total number of attributes. As an example we parse attribute-value pairs from the descriptions of the components and remove any conflicting components (1 kohm!=1.5 kohm) from the outputs. Furthermore, we could allow inequality of attributes that specify higher spec, for example tolerance 1%>5%. The results which is based on the machine learning confidence and attribute similarity can be also used as ordering priority. This helps user to see more relevant results first.

Optionally, the step of processing the raw output data for generating the processed output data comprises:
determining whether the electrical components of the first set and the second set include at least one non-matching electrical component, wherein a given non-matching electrical component is that whose class is different from a class of the given electrical component or whose attributes are conflicting with at least one attribute of the given electrical component;
when it is determined that the electrical components of the first set and the second set include the at least one non-matching electrical component, removing the at least one non-matching electrical component and its product data from the raw output data for identifying the at least one matching electrical component and having the product data of the at least one matching electrical component in the processed output data;
determining at least one attribute similarity between the at least one matching electrical component and the given electrical component;
determining at least one final confidence of matching the at least one matching electrical component with the given electrical component, using at least the at least one attribute similarity; and
arranging the product data of the at least one matching electrical component in a decreasing order of the at least one final confidence, and including the at least one final confidence along with the product data in the processed output data.

A technical advantage of processing the raw output data is that the electrical components that may have been accidentally included in the first set and the second set are removed, thereby ensuring that only the electrical components that are similar to the given electrical component is present in the raw output data. Herein, in one instance, the class of the given non-matching electrical component may be different from the class of the given electrical component. The class is inferred of the given non-matching electrical component using the pre-trained classification model, in a manner similar to inferring the class of the given electrical component, as is described above. In another instance, the attributes of the given non-matching electrical component are different than the at least one attribute of the given electrical component. The attributes of the given non-matching electrical component are inferred using in a manner similar to inferring the at least one attribute of the given electrical component. Thereafter, any non-matching electrical components are removed from the raw output data, so that the at least one matching electrical component can be identified accurately and correctly. The electrical components remaining in the raw output data are thereafter compared with the given electrical component, to determine at least one attribute similarity. Herein, the at least one attribute similarity may include, but are not limited to, a number of similar attributes found in the at least one matching electrical component and the given electrical component, a total number of attributes found in the at least one matching electrical component and the given electrical component, and the like. The at least one attribute similarity is given a weightage based on relevance of the at least one attribute with respect to the attribute of the given electrical component.

For example, a given electrical component may be a resistor with a value of 10 ohms, and the first set may include another resistor with a value of 100 ohms. Hence, the another resister does not match the resistor, and hence the another resistor along with its product data is removed from the raw output data.

Subsequently, the at least one final confidence of matching is computed for the at least one matching electrical component with the given electrical component. The at least one final confidence is calculated individually for every electrical component present in the raw output data. The pre-trained description matcher model and the pre-trained manufacturer part number matcher model computes an individual confidence of matching for every electrical component. Herein the confidence of matching computed by both the description matcher model and the manufacturer part number matcher model, respectively are added, and multiplied by 0.5. Thereafter, the at least one final confidence of matching is computed by added with a weightage associated with the at least one attribute similarity to the previously obtained confidence of matching, and then multiplied by 0.5. When the at least one final confidence is equal to 100%, then the at least one matching electrical component is an exact match to the given electrical component. Similarly, when the at least one final confidence is between 90% to 99%, then the at least one matching electrical component highly matches the given electrical component. Additionally, similarly, when the at least one final confidence is between 60% to 89%, then the at least one matching electrical component is a fair match for the given electrical component. Furthermore, when the at least one final confidence is lower than 60%, then the at least one matching electrical component is a low match for the given electrical component.

Optionally, the processed output data indicates the at least one matching electrical component which are devoid of at least one of: the outliers, the duplicates, the anomalies, the data imperfections. The processed output data is a clean representation of the at least one matching electrical component that can be used as alternates for the given electrical component. The output may be visually represented in the form of at least one of: an image, a table, an element of an user interface (such as, for example, a drop-down menu) wherein the at least one matching electrical component may be arranged in a decreasing order based on the confidence of matching. A technical advantage of generating the processed output data is that it helps to identify the at least one matching electrical component in a quick glance and hence, is time-efficient.

Optionally, the method further comprises:
receiving the dataset comprising the product data of the plurality of electrical components, wherein the product data comprises at least descriptions, manufacturer part numbers, and manufacturers, of the plurality of electrical components; and
processing the dataset for sanitizing the product data of the plurality of electrical components.

Optionally, the product data comprises a source of data of the plurality of electrical components. Herein, the manufacturers are the manufacturers of the plurality of electrical components, and the client names are source of the data row. The descriptions and the manufacturer part numbers are similar to the given description and the given manufacturer part number, as is described above. There may be approximately 10 million rows, with Not a Number (NaN) values and spurious rows. The dataset is processed to sanitize the product data, wherein the “sanitization” refers fixing or removing incorrect, corrupted, incorrectly formatted, or incomplete data within the dataset. A technical advantage of sanitizing the product data is that reliable visualizations, models, decisions, are generated.

Optionally, the step of processing the dataset for sanitizing the product data of the plurality of electrical components comprises at least one of:
removing at least one of: duplicate product data, spurious product data, Not a Number (NaN) values, common fill values, product data having suspicious lengths, special characters;
identifying aliases of the manufacturers and correcting the aliases; and
standardizing the descriptions according to a prescribed form.

A technical advantage of the aforementioned steps is that errors in the product data are removed, which improves ability of the rule-based cases and the machine learning to determine the at least one matching electrical component. In this regard, the “duplicate product data” refers to a product data that inadvertently shares the product data with another electrical component in the plurality of electrical components. The “spurious data” refers to unrelated information present in the product data, which has no relation whatsoever with the electrical component associated with the product data. The “Not a Number values” refers to a special floating-point value, wherein the NaN value cannot be converted to any other data type other than a float data type. The “common fill values” refers to current information in the product data, which is same as information available prior or after the current information in the product data. The product data may have suspicious lengths, wherein information in the product data either is very less than a threshold length or exceeds the threshold length of the product data. For example, the threshold length a manufacturer part number may be 12 characters. However, a description of 40 characters is received, which is of suspicious length. The “special characters” refers to a character that is not alphanumeric character or a numeric character. Examples of the special characters may include, but are not limited to, @, #, $, %, ∧, and the like. Hence, the at least one of: the duplicate product data, the spurious product data, the Not a Number (NaN) values, the common fill values, the product data having suspicious lengths, the special characters are removed to clean the product data.

Subsequently, the term “alias” refers to one or more names of the manufacturers. This leads to ambiguity, as the same manufacturer may seem like a different manufacturer in the product data. This is identified and corrected to maintain uniformity in the product data. Optionally, the descriptions is written in a random order, which is hard to comprehend by any user associated with any user device, and by the user device itself.

Hence, the descriptions are standardized by arranging information within the description in a manner perceivable by the user. The specifications are also standardized to maintain uniformity, and to easily read the description. For example, ‘1 K OHM’ may be standardized to ‘RES 1 KOHM’, ‘1/8 W’ may be standardized to ‘0.125 W’, and the like.

Consequently, the product data is sanitized, thereby considerably reducing the size of the dataset as compared to when it was received. For example, before sanitizing, the dataset may have comprised millions rows of product data. After sanitizing the product data, we have found out, that the rows of product data can be reduced by factor of 5.

Optionally, the method further comprises sending the processed output data to a user device associated with an entity, the processed output data being utilized in a purchase process performed by the entity. Herein, the term “user device” refers to an electronic device that is capable of at least receiving the processed output data. The user device is associated with (or used by) the entity and is advantageously, capable of enabling the entity to perform specific tasks associated with the method, such as the purchase process. Furthermore, the user device is intended to be broadly interpreted to include any electronic device that may be used to facilitate showing the processed output data to the user. Examples of the user device include, but are not limited to, a monitor, a display, a tablet, a phablet, a computer, a personal digital assistant (PDA), a laptop, and the like.

For example, the processed output data may be sent to the user device, such as, a computer associated with an electronics manufacturing services (EMS) company, wherein the EMS company designs, assembles, produces, and tests electronic components and printed circuit boards (PCB) assemblies for original equipment manufacturers (OEM). Hence, the processed output data may be sent to the user device, upon which there is initiated a request for quote (RFQ) process by the entity, based on the at least one matching electronic component. The processed output data may be in a form of a table, wherein the table comprises at least one of: a manufacturer part number, a job type, an order type, a client name, at least one date, a pricing, a status, a product data, of the electrical components. For each electrical component, there is also provided a list of matching electrical components.

The present disclosure also relates to the system as described above. Various embodiments and variants disclosed above, with respect to the aforementioned system, apply mutatis mutandis to the system.

The term “processor” relates to a computational element that is operable to respond to and processes instructions that drive the system. Furthermore, the term “processor” may refer to one or more individual processors, processing devices and various elements associated with a processing device that may be shared by other processing devices. Such processors, processing devices and elements may be arranged in various architectures for responding to and executing the steps of the system.

Optionally, the system further comprises a data repository communicably coupled to the at least one processor, wherein the data repository has stored thereat at least one of: the dataset comprising the product data of the plurality of electrical components, the specifications of the given electrical component, the raw output data, the processed output data. Herein, the term “data repository” refers to hardware, software, firmware, or a combination of these for storing a given information in an organized (namely, structured) manner, thereby, allowing for easy storage, access (namely, retrieval), updating and analysis of the given information. Herein, the given information is at least one: the dataset comprising the product data of the plurality of electrical components, the specifications of the given electrical component, the raw output data, the processed output data. The data repository may be implemented as a memory of the system, a removable memory, a cloud-based database, or similar. The data repository can be implemented as one or more storage devices. A technical advantage of using the data repository is that it provides an ease of storage and access of processing the input data, as well as processing outputs.

### DETAILED DESCRIPTION OF DRAWINGS

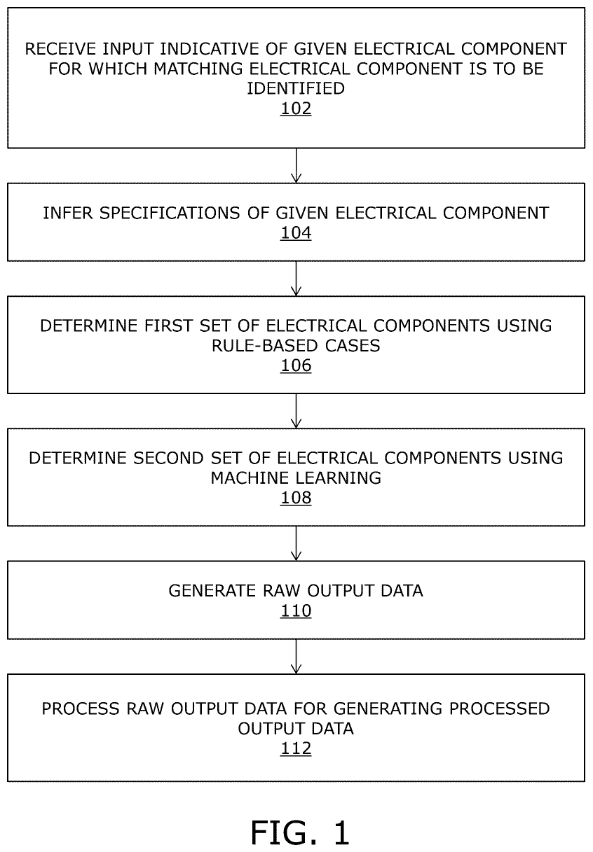

Referring to FIG. 1, there is shown an illustration of a flowchart depicting steps of a method for electrical component matching, in accordance with an embodiment of the present disclosure. At step 102, an input indicative of a given electrical component for which at least one matching electrical component is required to be identified is received, wherein the input comprises at least one of: a given manufacturer part number, a given description, of the given electrical component. At step 104, specifications of the given electrical component are inferred using the input, from a dataset comprising product data of a plurality of electrical components. At step 106, a first set of electrical components from amongst the plurality of electrical components is determined using rule-based cases applied corresponding to the specifications, wherein the electrical components of the first set match the given electrical component. At step 108, a second set of electrical components is determined from amongst the plurality of electrical components using machine learning, wherein the electrical components of the second set match the given electrical component. At step 110, raw output data comprising product data of the electrical components of the first set and the second set is generated. At step 112, the raw output data is processed for generating processed output data, wherein the processed output data comprises product data of the at least one matching electrical component identified from amongst the electrical components of the first set and the second set and a confidence of matching between the given electrical component and the at least one matching electrical component.

The aforementioned steps are only illustrative and other alternatives can also be provided where one or more steps are added, one or more steps are removed, or one or more steps are provided in a different sequence without departing from the scope of the claims herein.

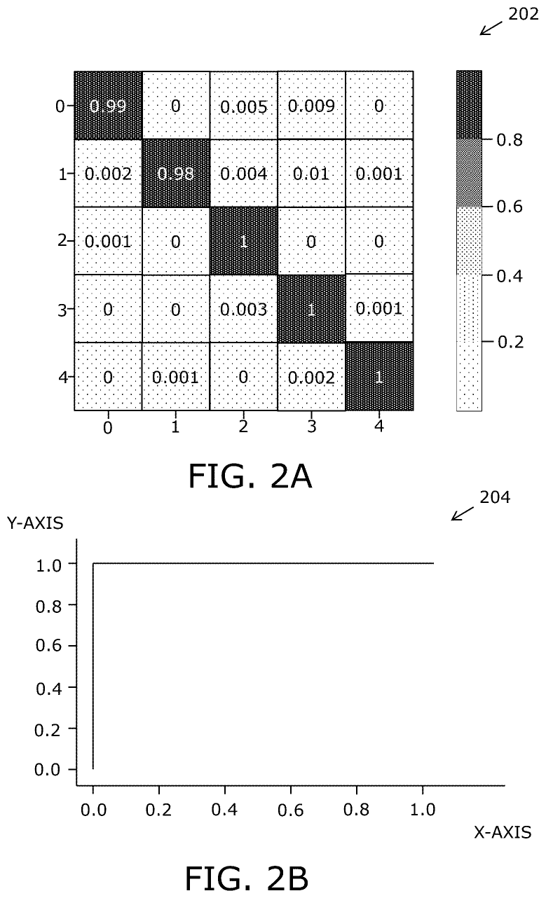

Referring to FIG. 2A, there are shown a normalized confusion matrix 202 and (FIG. 2B) a graph 204 corresponding to a performance of a classification model, in accordance with an embodiment of the present disclosure. Herein, a horizontal axis of the normalized confusion matrix 202 represents a predicted class of the electronic components in the plurality of electronic components, and a vertical axis of the normalized confusion matrix 202 represents a true class of the given electronic component. Each cell in the normalized confusion matrix 202 has a numeric value ranging from 0 up to 1. When a numeric value in a particular cell of the normalized confusion matrix 202 approaches 1, that means that the predicted class is the true class of electrical component.

The graph 204 of FIG. 2B is a receiver operating characteristics (ROC) curve, that is plotted between a true positive rate (TPR) of inferring the class of the given electrical component and a false positive rate (FPR) of inferring the class of the given electrical component, on Y-axis and X-axis respectively. The ROC summarizes the performance of the classification model by combining the confusion matrices of the classes inferred for the given electrical component, and determining an area under the ROC curve (AUC). The AUC provides an aggregate measure of classification by the classification model across class for the electrical components, which is known as AUC score.

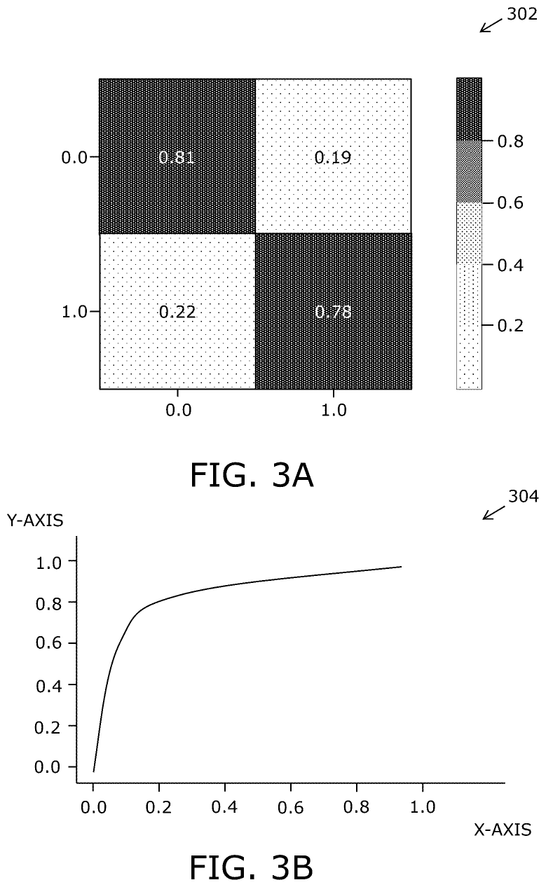

Referring to FIG. 3A, there are shown a normalized confusion matrix 302 and a graph 304 (FIG. 3B) corresponding to a performance of a description matcher model, in accordance with an embodiment of the present disclosure. The normalised confusion matrix 302 is a 2×2 matrix plotted between the true description match plotted on a vertical axis, and a false description match plotted on a horizontal axis. Each cell in the normalized confusion matrix 302 has a numeric value ranging from 0 up to 1. When a numeric value in a particular cell of the normalized confusion matrix 302 approaches 1, that means that the predicted description is the true description of electrical component.

The graph 304 of FIG. 3B is a receiver operating characteristics (ROC) curve, that is plotted between a true positive rate (TPR) of inferring the class of the given electrical component and a false positive rate (FPR) of inferring the class of the given electrical component, on vertical axis and horizontal axis respectively. The ROC summarizes the performance of the classification model by combining the confusion matrices of the classes inferred for the given electrical component, and determining an area under the ROC curve (AUC). The AUC provides an aggregate measure of classification by the classification model across class for the electrical components, which is known as AUC score. An XGBClassifier may be used to compute the AUC score. Herein, the AUC score is, for example, equal to 0.86.

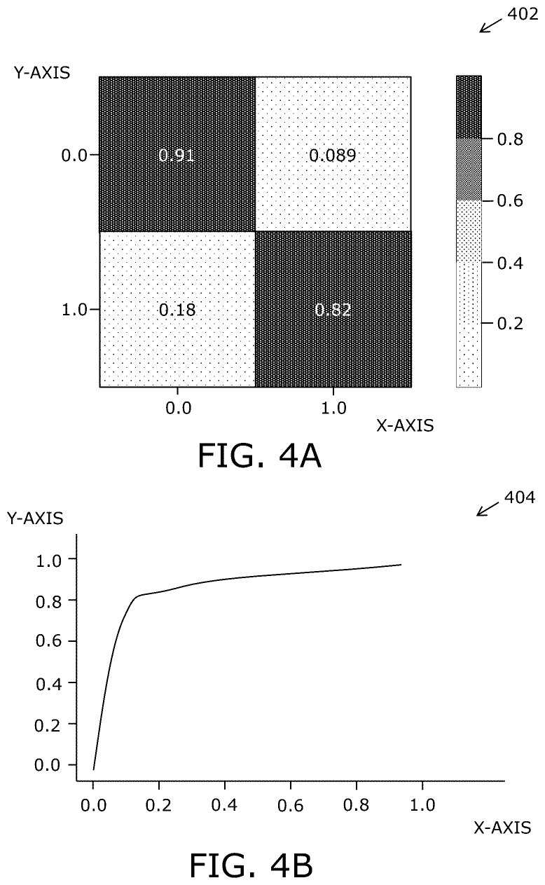

Referring to FIG. 4A, there is shown a normalized confusion matrix 402 and (FIG. 4B) a graph 404 corresponding to a performance of a manufacturer part number matcher model, in accordance with an embodiment of the present disclosure. The normalised confusion matrix 402 is a 2×2 matrix plotted between the true manufacturer part number plotted on vertical axis, and a false manufacturer part number plotted on horizontal axis. Each cell in the normalized confusion matrix 402 has a numeric value ranging from 0 up to 1. When a numeric value in a particular cell of the normalized confusion matrix 402 approaches 1, that means that the predicted manufacturer part number is the true manufacturer part number of electrical component.

The graph 404 of FIG. 4B. is a receiver operating characteristics (ROC) curve, that is plotted between a true positive rate (TPR) of inferring the class of the given electrical component and a false positive rate (FPR) of inferring the class of the given electrical component, on vertical axis and horizontal axis respectively. The ROC summarizes the performance of the classification model by combining the confusion matrices of the classes inferred for the given electrical component, and determining an area under the ROC curve (AUC). The AUC provides an aggregate measure of classification by the classification model across class for the electrical components, which is known as AUC score. An XGBClassifier may be used to compute the AUC score. Herein, the AUC score is, for example, equal to 0.93.

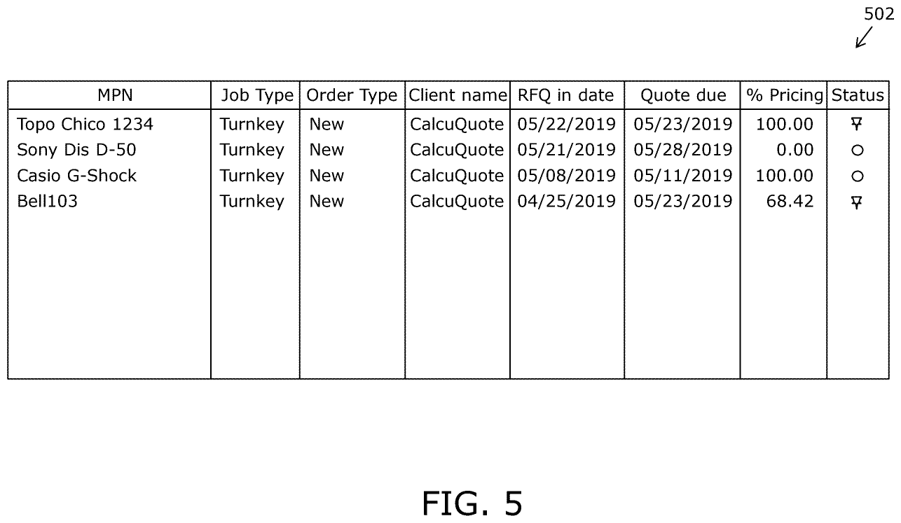

Referring to FIG. 5, there is shown an exemplary view 502 of a user interface during a purchase process performed by an entity, in accordance with an embodiment of the present disclosure. A processed output data of a method for electrical component matching is sent to a user device associated with the entity. The processed output data is utilized in the purchase process performed by the entity. The user device may, for example, be a computer associated with an electronics manufacturing services (EMS) company, wherein the EMS company designs, assembles, produces, and tests electronic components and printed circuit board (PCB) assemblies for original equipment manufacturers (OEMs). Hence, the processed output data may be sent to the user device, upon which there is initiated a request for quote (RFQ) process by the entity, based on the at least one matching electronic component. The processed output data may be in a form of a table, wherein the table comprises at least one of: a manufacturer part number (depicted as MPN), a job type, an order type, a client name, at least one date (depicted as RFQ in date and Quote due), a pricing, a status, a product data, of electrical components. For each electrical component, there is also to be provided a list of matching electrical components in the view 502 or in another view of the user interface.

FIG. 5 is merely an example and can have different arrangement and number of columns, which should not unduly limit the scope of the claims herein. A person skilled in the art will recognize many variations, alternatives, and modifications of embodiments of the present disclosure.

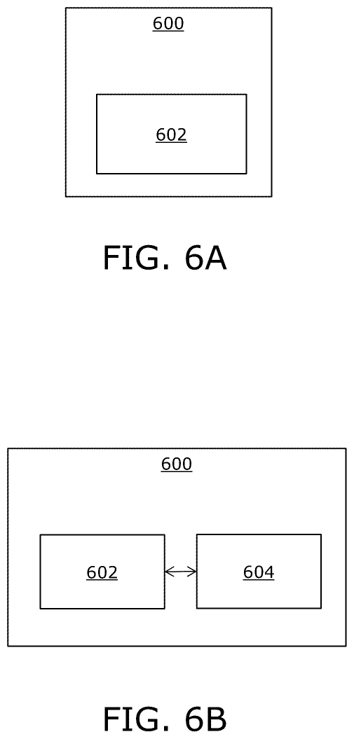

Referring to FIGS. 6A and 6B, there are shown block diagrams of a system 600 for electrical component matching, in accordance with an embodiment of the present disclosure. In FIG. 6A, the system 600 comprises at least one processor (depicted as a processor 602). In FIG. 6B, the system 600 further comprises a data repository 604. The data repository 604 is communicably coupled to the at least one processor 602.

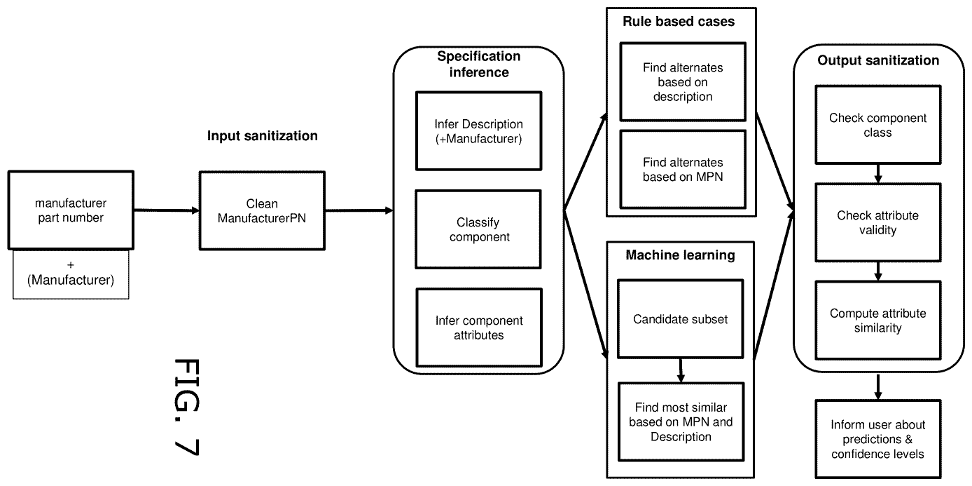

FIG. 7 is an illustration of example flow of embodiment. An input indicative of given electrical component is received. In the example this is manufacture part number and name of manufacturer. The input is sanitized to clean the input data to appropriate format. Specifications of the given electrical component are inferred. In the example description, component classification and component attributes are used. Output of the inference is used to determine a first set of components using rule based model. The output is also used to find a second set of components using machine learning model. The first and the second set are combined as a raw output data. The output is sanitized and processed to find product data for at least one matching electrical component. Confidence level of matching is indicated to user for the user to determine if the found component is good or not.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A computer implemented method for electrical component matching, the method comprising:
receiving an input indicative of a given electrical component for which at least one matching electrical component is required to be identified, wherein the input comprises at least one of: a given manufacturer part number, a given description, of the given electrical component;
inferring specifications of the given electrical component using the input, from a dataset comprising product data of a plurality of electrical components;
determining a first set of electrical components from amongst the plurality of electrical components using rule-based cases applied corresponding to the specifications, wherein the electrical components of the first set match the given electrical component;
determining a second set of electrical components from amongst the plurality of electrical components using machine learning, wherein the electrical components of the second set match the given electrical component;
generating raw output data comprising product data of the electrical components of the first set and the second set;
processing the raw output data for generating processed output data, wherein the processed output data comprises product data of the at least one matching electrical component identified from amongst the electrical components of the first set and the second set and a confidence of matching between the given electrical component and the at least one matching electrical component; and
wherein the method further comprising sending the processed output data to a user device associated with an entity, the processed output data being utilized in a purchase process performed by the entity.

2. The method according to claim 1, wherein the step of inferring the specifications of the given electrical component using the input comprises:
inferring the given description of the given electrical component when the input excludes the given description, based on at least one description associated with the given manufacturer part number in the dataset and a count of the at least one description, wherein the count of the at least one description comprises numeric value of number of times that the at least one description is associated with the given manufacturer part number, in the dataset;
inferring a class of the given electrical component using a pre-trained classification model, based on the given description of the given electrical component; and
inferring at least one attribute of the given electrical component using at least the at least one description.

3. The method according to claim 2, wherein the step of inferring the at least one attribute of the given electrical component using at least the at least one description comprises parsing the at least one description to identify at least one of: a unit, a value, an expression, a sequence, related to the at least one attribute.

4. The method according to claim 1, wherein the step of determining the first set of electrical components from amongst the plurality of electrical components using rule-based cases applied corresponding to the specifications comprises identifying an electrical component in the plurality of electrical components to belong to the first set when:
a manufacturer part number of the electrical component is same as the given manufacturer part number, but a manufacturer of the electrical component is different from a manufacturer of the given electrical component;
a description of the electrical component is same as the given description of the given electrical component, but a manufacturer and/or a manufacturer part number of the electrical component is different from a manufacturer and/or the given manufacturer part number of the given electrical component;
a manufacturer part number of the electrical component is different from the given manufacturer part number, but a description of the electrical component is same as the given description of the given electrical component;
or
a manufacturer part number of the electrical component is same as the given manufacturer part number and a description of the electrical component is same as the given description of the given electrical component.

5. The method according to claim 1, wherein the step of determining the second set of electrical components from amongst the plurality of electrical components using machine learning comprises:
determining a third set of electrical components from amongst the electrical components, wherein the electrical components of the third set are similar to the given electrical component;
employing at least one of:
a pre-trained description matcher model for determining first similarity values indicative of a similarity between descriptions of the electrical components in the third set and the given description of the given electrical component;
a pre-trained manufacturer part number matcher model for determining second similarity values indicative of a similarity between manufacturer part numbers of the electrical components in the third set and the given manufacturer part number of the given electrical component;
comparing the first similarity values and/or the second similarity values against a first threshold value and/or a second threshold value, respectively; and
identifying an electrical component in the third set to belong to the second set when its first similarity value and/or second similarity value is/are greater than the first threshold value and/or the second threshold value, respectively.

6. The method according to claim 25, wherein the step of determining the third set of electrical components from amongst the electrical components comprises:
identifying, from amongst the plurality of electrical components, at least two of:
a fourth set of electrical components that have a description that is similar to the given description of the given electrical component;
a fifth set of electrical components that have a manufacturer part number that is similar to the given manufacturer part number of the given electrical component;
a sixth set of electrical components that have one or more attributes that are similar to the at least one attribute of the given electrical component; and
identifying an electrical component to belong to the third set when said electrical component belongs to at least two of: the fourth set, the fifth set, the sixth set.

7. The method according to claim 6, further comprising parsing descriptions of the plurality of electrical components to determine attributes of the plurality of electrical components, prior to the step of identifying, from amongst the plurality of electrical components, the sixth set of electrical components.

8. The method according to claim 5, further comprising:
training a description matcher model using a first training dataset for generating the pre-trained description matcher model, the first training dataset comprising one or more sets of different descriptions matched to a same manufacturer part number; and/or
training a manufacturer part number matcher model using a second training dataset for generating the pre-trained manufacturer part number matcher model, the second training dataset comprising one or more sets of different manufacturer part numbers matched to a same description and/or a same source of data.

9. The method according to claim 1, wherein the step of processing the raw output data for generating the processed output data comprises:
determining whether the electrical components of the first set and the second set include at least one non-matching electrical component, wherein a given non-matching electrical component is that whose class is different from a class of the given electrical component or whose attributes are conflicting with at least one attribute of the given electrical component;
when it is determined that the electrical components of the first set and the second set include the at least one non-matching electrical component, removing the at least one non-matching electrical component and its product data from the raw output data for identifying the at least one matching electrical component and having the product data of the at least one matching electrical component in the processed output data;
determining at least one attribute similarity between the at least one matching electrical component and the given electrical component;
determining at least one final confidence of matching the at least one matching electrical component with the given electrical component, using at least the at least one attribute similarity; and
arranging the product data of the at least one matching electrical component in a decreasing order of the at least one final confidence, and including the at least one final confidence along with the product data in the processed output data.

10. The method according to claim 1, further comprising:
receiving the dataset comprising the product data of the plurality of electrical components, wherein the product data comprises at least descriptions, manufacturer part numbers, and manufacturers, of the plurality of electrical components; and
processing the dataset for sanitizing the product data of the plurality of electrical components.

11. The method according to claim 10, wherein the step of processing the dataset for sanitizing the product data of the plurality of electrical components comprises at least one of:
removing at least one of: duplicate product data, spurious product data, Not a Number (NaN) values, common fill values, product data having suspicious lengths, special characters;
identifying aliases of the manufacturers and correcting the aliases; and
standardizing the descriptions according to a prescribed form.

12. (canceled)

13. A system for electrical component matching, the system comprising at least one processor configured to implement steps of the method of claim 1.

14. The system according to claim 13, further comprising a data repository communicably coupled to the at least one processor, wherein the data repository has stored thereat at least one of: the dataset comprising the product data of the plurality of electrical components, the specifications of the given electrical component, the raw output data, the processed output data.
